(19) United States
(12) Patent Application Publication
(10) Pub. No.: US 2009/0113642 A1
(43) Pub. Date: May 7, 2009

(54) DEVICE FOR WASHING LIQUID TURBULATION FOR ROTARY JET HEADS, ESPECIALLY WATER-CLEANING MACHINES

(75) Inventor: ROBERTO ZINGONI, REGGIO EMILIA (IT)

Correspondence Address: Pearne & Gordon LLP, 1801 East 9th Street, Suite 1200, Cleveland, OH, 44114-3108, US

(73) Assignee: ARROW LINE S.R.L., RUBIERA (REGGIO EMILIA) (IT)

(21) Appl. No.: 11/935,805

(22) Filed: Nov. 6, 2007

(51) Int. Cl. B08B 9/00

(52) U.S. Cl. 15/3.5

(57) ABSTRACT

A device for washing liquid turbulation for rotary jet heads, especially for water-cleaning machines. The head comprises a main body exhibiting an inlet, coupled with a closure body, exhibiting an outlet, and defining together with the main body, an internal chamber. A dispensing nozzle of the washing liquid is housed in the internal chamber and is mobile with a conical rotary motion having a vertex thereof in the frontal portion. The turbulation device, also located in the internal chamber upstream of the nozzle, comprises means for conveying for facilitating a flow of liquid from the inlet to the internal chamber with helical motion, impressing the conical rotary motion on the nozzle.

### BACKGROUND OF THE INVENTION

The invention relates to a device for washing liquid turbulation for rotary jet heads, especially for water-cleaning machines.

As is known, high-pressure washing pistols for water-cleaning machines can, in an example of application, terminate frontally with a rotating-nozzle head.

The rotating-nozzle head comprises a substantially-tubular main body and a posterior portion having an inlet connection exhibiting an inlet conduit for washing liquid.

The dispensing nozzle is housed internally of a front cavity of the main body.

In rotating heads the nozzle is mobile internally of the front cavity, which in this case takes on a conformation and dimensions which are adequate to the motion of the nozzle. The nozzle frontally abuts against an annular seating inserted in the frontal cavity of the main body, and is set in rotation to a swirling liquid flow internally of a cylindrical bushing, the nozzle axis also rotating according to a conical generatrix with the vertex in the annular seating.

The swirling liquid flow is obtained by a special turbulation device located upstream of the frontal cavity. A jet is emitted in outlet from the head, which jet rotates with a trajectory that is similar to the dispensing nozzle.

In the prior art the above-cited turbulation device is generally constituted by a closure element arranged downstream of the inlet conduit and exhibiting at least a through-hole which is skewed with respect to the longitudinal axis of the main body such as to form a corresponding oblique jet which generates the swirling motion.

FIG. 1 illustrates an example from the prior art constituted by a fluid turbulation device conformed as a truncated cylinder in which two skewed holes are made, with respect to the longitudinal axis thereof, such as to form a pair of jets which are orientated obliquely, with a same direction and opposite sense, developing a torque.

The above-cited prior art exhibits some limitations and drawbacks.

Firstly, the swirl of the flow of washing liquid investing the posterior portion of the nozzle is not very strong since it is only determined by the obliqueness in outlet from the turbulation device of the two jets which are substantially straight as they exit from the skewed holes passing through the device. Consequently, even the rotary thrust exerted on the nozzle is not particularly relevant and effective in impressing a powerful and high-angular-velocity rotary motion on the nozzle.

Further, with the aim of inducing high rotary velocity on the nozzle, the diameter of the skewed holes is narrowed in order to increase the outlet velocity of the jets. Therefore, the skewed through-holes of the turbulation device normally exhibit small diameters and are easily subject to blockage: this leads to the need for frequent dismounting of the head in order for the conveying device to be extracted and maintained.

Finally, the known-type turbulation devices suffer from high load-loss due to the narrowness of the through-holes they are provided with.

Indeed, the passage of the fluid through the skewed holes leads to three types of energy loss: a first loss occurs at the entry of each hole, a second loss due to the turbulent motion inside the hole and a third loss connected with the almost total dissipation of the kinetic energy of the jets exiting the conduits.

These losses, which all translate into pressure losses, cause a pressure reduction of the washing liquid exiting the head.

In order to induce the rotation on the nozzle, a large pressure leap is used, to the detriment of the pressure required to effect a good wash.

Consequently, in the prior-art rotating nozzle heads the majority of the pressure energy of the fluid is used to induce the rotation of the nozzle, and therefore not for the actual washing operation.

In this situation, the general aim of the present invention is to provide a washing liquid turbulation device for a rotating jet head, particularly for water jet washing machines, which substantially obviates the cited drawbacks in the prior art.

In the ambit of the general aim of the invention, an important aim of the present invention is to provide a turbulation device which provides a washing liquid having high level of swirl, which is able to impress a rotary thrust on the dispensing nozzle without suffering high load loss.

A further important aim of the invention is to provide a turbulation device which only rarely requires maintenance operations in order to stay in good efficient working order, thus preventing time losses due to frequent dismounting of the head in which it is inserted.

A further and not less important aim is to provide a turbulation device which suffers only limited pressure losses of the washing liquid before the liquid enters inside the dispensing nozzle.

The specified aims are substantially attained by a turbulation device which is characterised in that it comprises one or more of the technical solutions claimed in the appended claims.

### BRIEF DESCRIPTION OF THE DRAWINGS

A description will now be made of a preferred but not exclusive embodiment of the device of the invention, illustrated by way of non-limiting example in the accompanying figures of the drawings, in which:

FIG. 1 is a partially-sectioned perspective view of a prior-art example of a turbulation device for washing liquid for rotating jet heads;

FIG. 2 is a longitudinal section of a rotating jet head comprising the device of the invention;

FIG. 3 is a perspective view of a first example of application of a turbulation device of washing liquid with a rotary jet head of the present invention;

FIG. 4 is a perspective view of the device of FIG. 3, provided with a variation;

FIG. 5 is a perspective view of a second embodiment of a turbulation device of washing liquid for rotating jet heads according to the present invention.

### DESCRIPTION OF THE PREFERRED EMBODIMENTS

With reference to the figures of the drawings, the turbulation device of the invention is denoted in its entirety by number 1.

The turbulation device 1 is inserted in a head 2 defined by a coupling of a main body 3, which is tubular, with a closure body 5, also tubular.

The main body 3 exhibits an inlet 4 which communicates with a first chamber 21 through a second narrowing of section 20.

The inlet 4 is preferably located upstream of the first chamber 21.

Similarly, the closure body 5 exhibits an exit 6 communicating with a second chamber 23 through a third narrowing of section 22.

The outlet 6 is preferably located downstream of the second chamber 23.

The coupling of the main body 3 with the closure body 5, realised in a preferred embodiment by a screw thread, defines, through the first chamber 21 and the second chamber 22, an internal chamber 3b in the head 2.

A dispensing nozzle 7 is located internally of the internal chamber 3b, the nozzle 7 exhibiting a frontal first portion 7a engaged contactingly on the closure body 5 and a posterior second portion 7b which is free and conically rotatingly mobile with respect to the vertex of the frontal first portion 7a.

The closure body 5 exhibits a striker body 24 in striking contact with the third narrowing of section 22, opposite the outlet 6, on which striker body 24 the frontal first portion 7a of the nozzle is engaged.

A turbulation device 1 is also located internally of the internal chamber 3b, which device 1 is located upstream of the dispensing nozzle 7 and facilitates, via means for conveying 8, the flow of liquid from the inlet 4 of the internal chamber 3b with a substantially helical motion for impressing the conical rotary motion on the nozzle 7.

The turbulation device 1 exhibits a substantially trunco-cylindrical shape, with a circular external wall D.

In the embodiment illustrated in FIGS. 2-5 the turbulation device 1 is preferably defined by a cylindrical body 12 exhibiting a first side 13, a second side 14 and a lateral wall 15 which joins the first side 13 and the second side 14.

The means for conveying 8 are located directly on the external wall D and exhibit a helical shape.

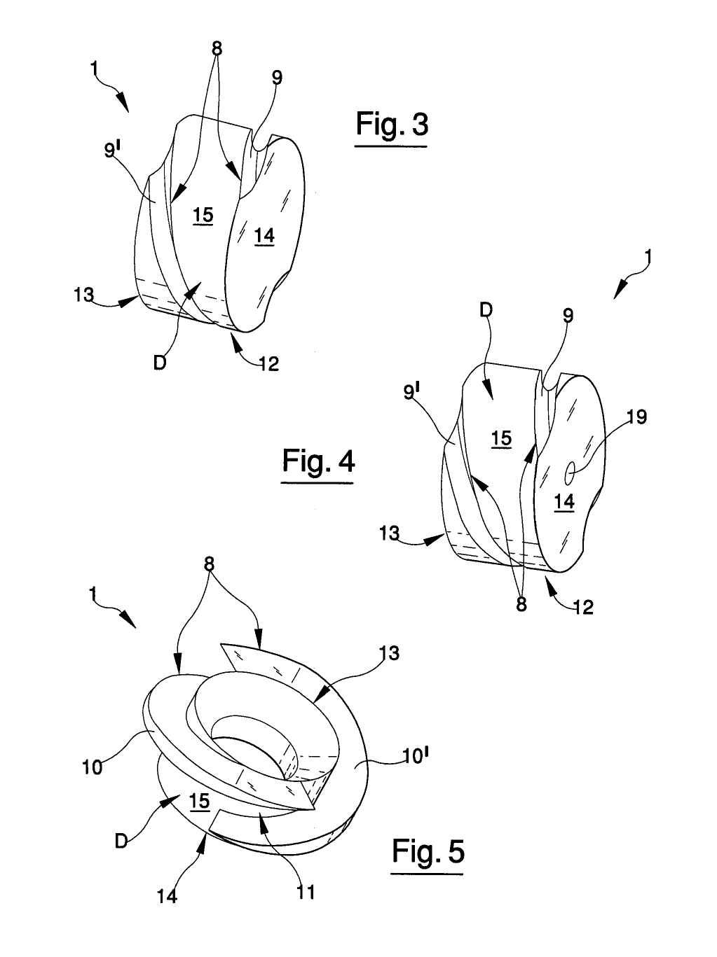

In a first embodiment, illustrated in FIGS. 3 and 4, the means for conveying 8 are defined by at least a channel 9 afforded on the external wall D, more precisely on the lateral wall 15 of the cylindrical body 12, and developing over the whole height of the turbulation device 1.

In the preferred embodiment a pair of helical channels 9, 9′ are afforded, turning in a same direction and remaining equidistant from one another for the whole development thereof.

The liquid flow in the channels takes on a helical motion with high hydrodynamic performance, and enters the internal chamber 3b, inducing a circular thrust on the nozzle 7.

More precisely, there will be a substantially helical motion in the chamber 3b, generated by the passage of the fluid through the channels 9, 9′.

In addition to the channel 9, the means for conveying 8 can further comprise a central through-hole 19.

The central through-hole 19 has the function of partialising the flow rate conveyed by the channel, and thus to attenuate the induction effect of the rotation of the nozzle 5, and also to reduce the load loss due to the passage of the liquid through the device.

In a second embodiment illustrated in FIG. 5, the means for conveying are constituted by at least a pair of projections 10, 10′, projecting from the external wall D, defining internally thereof a channel 11 having a helical development.

The main body 3 can comprise a tubular body 16, coupled to the first chamber 21, which tubular body 16 exhibits a first narrowing of section 17 and an internal wall 18.

The cylindrical body 12 exhibits a first external diameter 13 which strikes against the first narrowing of section 17.

In the first embodiment the external wall D of the turbulation device 1 is stably coupled to the internal wall 18 of the tubular body 16.

In the second embodiment, the external wall D of the turbulation device 1 is also stably coupled to the internal wall 18 of the tubular body 16, but the coupling is limited to the terminal portion of the pair of projections.

Obviously the choice of which of the two devices of FIG. 3 and FIG. 4 and FIG. 5 to install depends on the flow rate and pressure characteristics desired; it is simple however to substitute one device for another.

The device of the invention can be easily removed from the internal chamber 3b in order to be cleaned or replace with another device, which can have different characteristics on the basis of the type of jet required.

The functioning of the head 2 of FIG. 2 fitted to the turbulation device 1 of FIG. 3 or 4 is as follows.

The pressurised liquid enters the chamber 4 and proceeds by moving across the means for conveying 8, which in the specific case are defined by a pair of channels 9, 9′, up until it reaches the internal chamber 3b, supplying the nozzle 7.

The motion of the fluid becomes swirling in the chamber 4, crossing the turbulation device 1, thanks to the forced passage of the fluid inside the pair of channels 9, 9′.

The functioning of the head 2 of FIG. 2 fitted to the turbulation device 1 of FIG. 5 is as follows.

The pressurised liquid enters the chamber 4 and proceeds by moving through the means for conveying 8, which in the specific case are defined by a pair of projections 10, 10′, up until it reaches the internal chamber 3b, supplying the nozzle 7.

The motion of the fluid becomes swirling in the chamber 4, crossing the turbulation device 1, thanks to the forced passage of the fluid inside the pair of projections 10, 10′.

The invention provides important advantages.

Firstly, the helical channel the device is provided with enables a washing liquid flow that is well orientated in the rotating direction and is thus able to impress a powerful thrust on the nozzle, causing it to move quickly in the same direction.

The helical motion is optimal for creating an effective thrust and is also a good source of supply to the nozzle 7, the former because of the rotary component of the helical motion, the latter because of the translating component of the helical motion.

Consequently, and importantly, a good rotation of the liquid contained in the chamber containing the dispensing nozzle 7 is obtained, with a small load loss.

A large part of the pressure in inlet is made available for the primary function of washing.

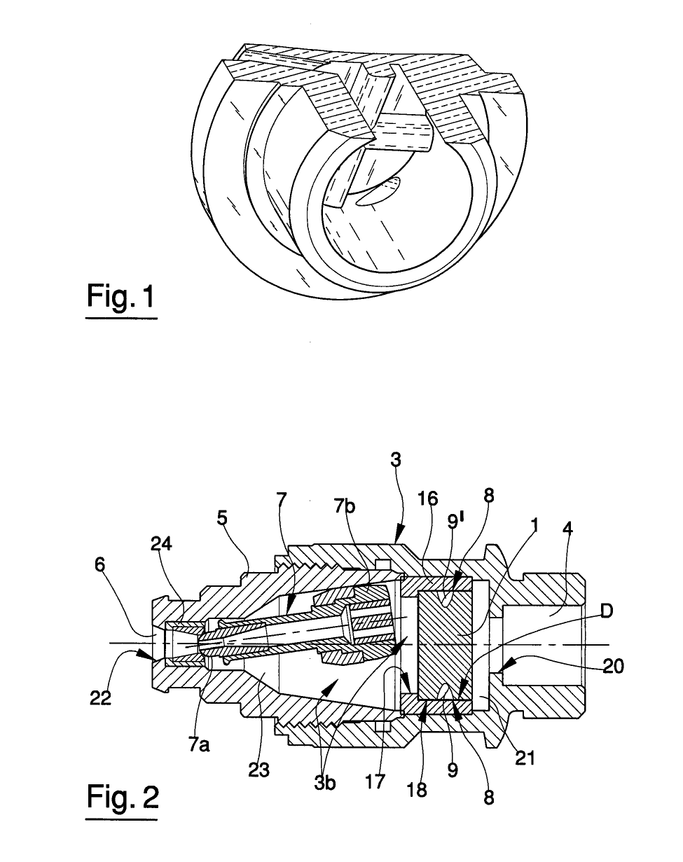

In comparison with the example taken from the prior art of FIG. 1, the rotation torque impressed in the prior art has a limited rotation arm, while in the invention the torque arm is the maximum possible as it coincides with the external diameter of the conveyor.

Further, it is stressed that the conduit through which the washing liquid flow is forced to move by the device of the invention is of a relevant width; the possibility of blockage caused by any residues present in the liquid and the load losses caused thereby are therefore very much reduced.

The use of means for conveying 8, as illustrated in the embodiments of FIGS. 3 and 5, in place of the usual conveyor holes, make possible an immediate cleansing of the conduits without there being any need to have special pointed tools available for unblocking the obstructed holes.

Finally, the device of the invention can be realised by moulding without any need to perform cutting operations on the body of the head to remove parts of material and create the skewed through-holes comprised in the prior art.

What is claimed:

1. A device for washing liquid turbulation for rotary jet heads, especially for water-cleaning machines, the head comprising:
a main body which is tubular and which exhibits an inlet;
a closure body, exhibiting an outlet, the closure body being coupled to the main body and defining, together with the main body, an internal chamber;
a dispensing nozzle of the washing liquid, which dispensing nozzle is housed in the internal chamber and exhibits a frontal portion which is contactingly engaged to the closure body, and a free posterior portion opposite the frontal portion, the nozzle being mobile with a conical rotary motion having a vertex thereof in the frontal portion;
the turbulation device, also located in the internal chamber upstream of the nozzle, exhibiting a substantially trunco-cylindrical shape and an external wall having a curved development;
wherein the turbulation device comprises means for conveying located at the external wall for facilitating a flow of liquid from the inlet to the internal chamber with helical motion, impressing the conical rotary motion on the nozzle.

2. The turbulation device of claim 1, wherein the means for conveying exhibit a helical progression.

3. The turbulation device of claim 1, wherein the means for conveying are defined by at least a channel, afforded in the external wall of the turbulation device, having a helical progression.

4. The turbulation device of claim 1, wherein the means for conveying are defined by at least a pair of projections, projecting from the external wall of the turbulation device, defining internally thereof a channel having a helical progression.

5. The turbulation device of claim 1, wherein the turbulation device is defined by a cylindrical body exhibiting a first side, a second side and a lateral wall which connects the first side and the second side.

6. The turbulation device of claim 5, wherein the main body is coupled at the internal chamber with a tubular body exhibiting a first narrowing of section and an internal wall.

7. The turbulation device of claim 6, wherein the cylindrical body exhibits the first side in striking contact with the first narrowing of section and the lateral wall preferably friction coupled on the internal wall.

8. The turbulation device of claim 3, wherein the means for conveying can include, in addition to the at least a channel, at least a central through-hole.

9. The turbulation device of claim 1, wherein the main body exhibits a second narrowing of section interposed between the inlet and a first chamber, the first chamber being located downstream of the inlet.

10. The turbulation device of claim 1, wherein the closure body exhibits a first narrowing of section interposed between the outlet and a second chamber, the second chamber being located upstream of the outlet.

11. The turbulation device of claim 9, wherein the first chamber and the second chamber define the internal chamber, through the coupling with the main body and the closure body.

12. The turbulation device of claim 10, wherein the first chamber and the second chamber define the internal chamber, through the coupling with the main body and the closure body.
